(19) United States
(12) Patent Application Publication
(10) Pub. No.: US 2006/0123063 A1
(43) Pub. Date: Jun. 8, 2006

(54) Audio and video data processing in portable multimedia devices

(76) Inventors: William J. Ryan, Algonquin, IL (US); Ankur Mehrotra, Ujjain (IN); Ravi Kant Rao, Bangalore (IN)

Correspondence Address: MOTOROLA INC, 600 NORTH US HIGHWAY 45, ROOM AS437, LIBERTYVILLE, IL, 60048-5343, US

(21) Appl. No.: 11/007,374

(22) Filed: Dec. 8, 2004

(51) Int. Cl. G06F 17/30

(52) U.S. Cl. 707/201

(57) ABSTRACT

A multimedia enabled portable communication device and method, including a real-time processor (110) and an application processor (120) communicably coupled to a synchronization entity (112). In one embodiment the synchronization entity is an H.324 entity integrated with the real-time processor. The synchronization entity synchronizes a video data stream from the application processor with an audio data stream from the real-time processor based on delay information.

### FIELD OF THE DISCLOSURE

The present disclosure relates generally to data stream processing in electronic devices, and more particularly to processing unsynchronized data streams, for example, audio and video data streams in multimedia enabled wireless communication devices, and methods.

### BACKGROUND

In many multimedia enabled wireless communication terminals, audio and video are referenced to a common timing source and multiplexed within a single core processor that captures encoded audio and video information from associated digital signal processing (DSP) devices, wherein the audio and video input and output is tightly coupled. These known architectures are designed to provide a nearly constant set of qualities including, among others, audio and video synchronization.

The 3GPP and 3GPP2 standards bodies have adopted the circuit-switched H.324M protocol for enabling real-time applications and services over 3^{rd} Generation (3G) wireless communication networks including Universal Mobile Telecommunications System (UMTS) WCDMA and CDMA 2000 protocol networks. Exemplary applications and services include, but are not limited to, video-telephony and conferencing, video surveillance, real-time gaming and video on-demand among others.

In H.324M, audio and video information is transmitted unsynchronized, although the H.324M protocol provides instructions and interfaces for generic audio/video delay compensation at the receiving device. H.324M provides, more particularly, for a skew indication message that allows the transmitting terminal to report skew between audio and video data streams to the receiving terminal, which may then compensate to provide synchronized data streams, for example, lip synchronized audio and video data. In the H.324M protocol, however, synchronization is not mandatory and the receiving terminal is not required to utilize the skew information to provide synchronization.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is a block diagram representation of an exemplary portable multimedia device.

FIG. 2 depicts an exemplary audio and video queuing mechanism for managing audio and video skew.

FIG. 3 depicts a selective discard procedure to dynamically reduce audio and video skew.

FIG. 4 depicts a selective insertion procedure to dynamically increase audio and video skew.

FIG. 5 is an exemplary process flow diagram.

### DETAILED DESCRIPTION

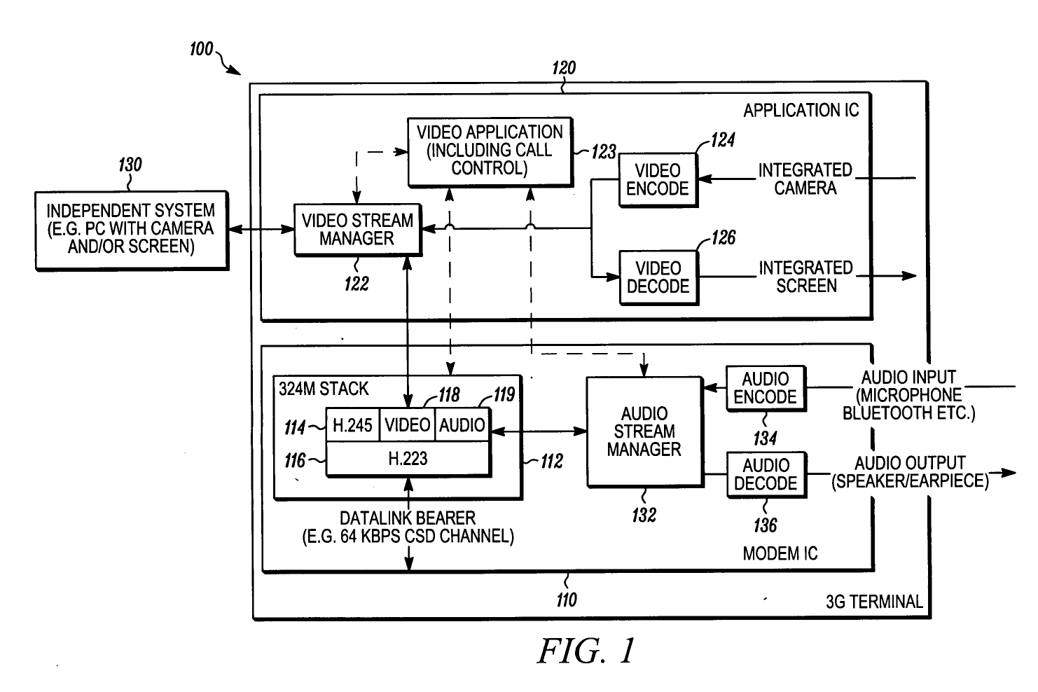

FIG. 1 is a portable multimedia device in the exemplary form of a wireless communication terminal 100 including a modem 110 and an application entity 120, which provide unsynchronized audio and video data streams which are multiplexed before transmission as discussed more fully below. In one embodiment, for example, a generic interface may be used to route video to a PC or to perform video insertion from a camera, e.g., video capture and/or rendering over a Universal Serial Bus (USB) port, not integrated with the audio source. Generally there are other applications and embodiments where separate data streams originate from or are provided by unsynchronized sources. It is immaterial in the present disclosure why the data stream sources are not synchronized.

In some embodiments, a change in the source or sources from which one of more of the data streams originate affects the timing. For example, changing the source of an audio data stream from a speakerphone to a Bluetooth headset may change the timing, or skew, of the audio data stream relative to a corresponding video data stream with which it may be desirable to synchronize the audio data stream. In some applications, the delay between multiple data streams from the unsynchronized sources changes as dynamically a result of some processing one or both of the data streams. A change in timing may result, for example, from subjecting a portion of one or both of the data streams to encoding or other processing, for example, Digital Rights Management (DRM) encoding.

In other embodiments, it may be unnecessary to synchronize audio and video when the video is obtained from one source, but it may be desirable to synchronize the audio and video when the video is obtained from another source. Some cellular telephones, for example, include multiple cameras, one or the other of which may be selected by the user. When a camera that faces away from the user is selected, synchronization with audio may not be an issue. When a camera facing the user is selected however, lip synchronization is generally desired. Thus in some embodiments, audio and video synchronization is desired, depending upon which video source is selected.

In the instant disclosure, skew is near constant delay between the unsynchronized sources from which first and second data streams are obtained. In one embodiment, for example, the skew is a median or average based on jitter and delay differences between the unsynchronized data stream sources. Generally, the unsynchronized sources either originate or operate as conduits for the data streams.

In one embodiment, the modem 110 is a wireless modem that supports a cellular communication protocol, for example, Global System for Mobile Communications (GSM) protocol, 3^{rd} Generation (3G) Universal Mobile Telecommunications System (UMTS) W-CDMA protocol, or one of the several CDMA protocols, among other cellular communication protocols. Alternatively, the modem may be compliant with some other wireless communication protocol including, among others, local area network protocols, like IEEE 802.xx, personal area network protocols like Bluetooth, and wide area network protocols. In other embodiments, the modem is a short range wireless modem, for example, a DECT compliant or other cordless telephone protocol. Alternatively, the modem may be a wire-line modem. Although the exemplary multimedia device includes a modem, more generally the instant disclosure does not require a modem. Such non-modem equipped devices include personal digital assistants (PDAs), multimedia players, audio and video recording devices, laptop and notebook computers, among other portable devices, any one of which may also include a wireless modem.

The exemplary modem 110 includes an audio input from an audio manager entity 132. The audio stream manager receives an audio data stream from an audio encoder 134 and provides audio output to an audio decoder 136. The encoder 134 obtains audio input from at least one source, though more generally the audio input may be selected from one of several sources under control of the audio manager entity. In one embodiment, for example, the audio manager entity selects audio from a handset microphone, or a speakerphone, or a Bluetooth headset or from some other source. In some embodiments, the audio codec is implemented in a DSP processor, which may be packaged as part of the modem integrated circuit (IC) or as a separate entity. Each of the exemplary audio sources will generally have a unique delay relative to a corresponding video data stream, for example, captured by camera, examples of which are discussed further below. The exemplary modem receives a real-time voice data stream.

In FIG. 1, the exemplary application entity 120 comprises generally a video stream manager entity 122 for managing video data originated from different sources. The exemplary multimedia device 110 is communicably coupled to an accessory 130, for example, a camera or a video recorder, providing a video data stream to the video stream manager 122. The exemplary application entity also includes a video encoder 124 having as an input an integrated camera engine, and a video decoder 126 having a video signal output, for example, to a display device. The video stream manager 122 of the exemplary application processor 120 is thus a conduit for video data streams originated from other sources. In some embodiments, the selection of the data stream is user controlled and in other embodiments the selection is controlled automatically by an application. Generally, the source and particular type of data streams managed by the management entity 123 and how the video data stream selection is made are immaterial. Alternatively, the video data stream inputs to the video stream manger may all originate from integrated sources or from accessories.

In FIG. 1, generally, the modem 110 performs audio and video multiplexing prior to transmission of the multiplexed audio and video data. In some embodiments, the audio and video data streams are synchronized before multiplexing as discussed further below. The modem 110 also obtains video data from an independent, unsynchronized processor, which is part of the application entity 120 in the exemplary embodiment. From the perspective of the modem 110, the video data stream originates from the application entity 120, although in some embodiments the application entity 120 is merely a conduit for video data originated from another source, for example, from the accessory 130 or from some other source as discussed above. It is not necessary that the multiplexer be part of one of the modem. Generally, in applications where multiplexing is required, the multiplexer could be an entity separate from both data stream sources. The disclosure is not limited, however, to embodiments or applications where the data streams are multiplexed.

In FIG. 1, the exemplary modem 110 includes an H.324M protocol entity 112 for enabling real-time applications and services over 3^{rd} Generation (3G) wireless communication networks. The H.324M protocol entity includes a H.245 module 114 that specifies a call control protocol, including exchange of audio and video capabilities, master/slave determination, signaling opening and closing of logical channels, among other functions. The H.324M protocol entity also includes a H.223 module 116 that multiplexes and de-multiplexes signaling and data channels. Particularly, the H.223 multiplexer 116 multiplexes a video data stream on an audio channel 118, an audio data stream on an audio channel 119 and control and signaling information on the H.245 channel 116. The H.223 protocol supports the transfer of combinations of digital voice/audio, digital video/image and data over a common communication link. In FIG. 1, the H.223 output is communicably coupled to an exemplary 64 kbps circuit switch data (CSD) channel. In some embodiments the multiplexer is a discrete entity separate from the unsynchronized entities. In other embodiments, the multiplexer is not necessarily compliant with the H.324 protocol. In other embodiments, data streams from other unsynchronized sources are multiplexed by some other multiplexer, for example, an H.323 entity, which is the packet-based counterpart of the H.324 entity.

In FIG. 1, the application entity 120 initiates and terminates H.324M calls while controlling the establishment of selected video capture and render paths, as discussed above. The source of the video data stream, for example, from the accessory 130 or from the integrated camera encoder 124 in FIG. 1, will generally impact the audio and video timing, since these sources are not synchronized with the modem 110, which is the source for the audio data stream.

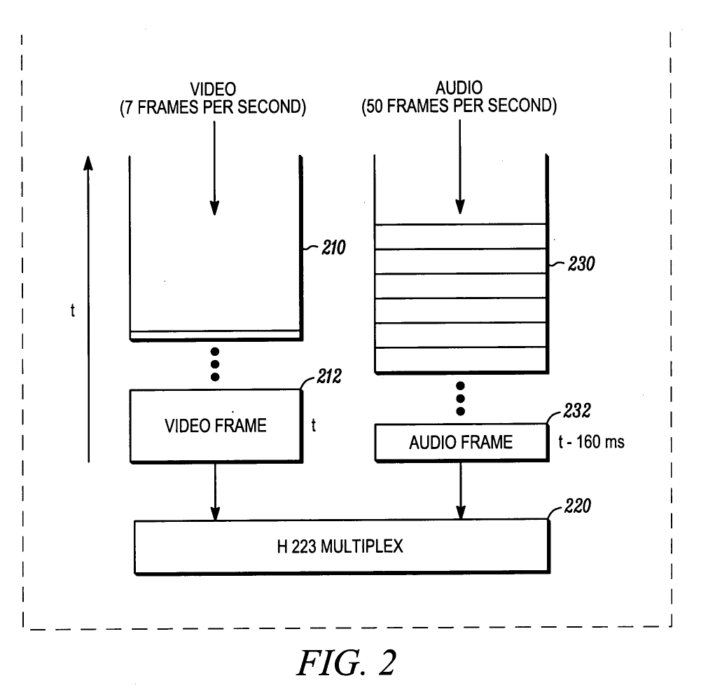

FIG. 2 illustrates an audio and video queuing mechanism for managing audio and video skew in the exemplary H.324 stack. In one embodiment the audio and video data streams are synchronized in the H.324 entity before multiplexing. The application processor provides a video data stream 210 comprising video frames 212 to the exemplary H.223 multiplexer 220 at an exemplary rate of seven frames per second (7 frames/sec). The modem provides an audio data stream 230 comprising audio frames 232 to the multiplexer at an exemplary rate of fifty audio frames per second (50 frames/sec).

In the exemplary embodiment of FIG. 1, synchronization occurs prior to multiplexing the control, video and audio channels. Particularly, skew information is used to determine when to provide the audio and video data streams to the H.223 multiplexer to ensure synchronization. The skew information is known dependent upon the source from which the data stream is obtained or based on other known information. In the exemplary embodiment, the synchronization occurs outside of the audio and video codecs since there are system-level overheads that the codecs cannot account for. In the exemplary embodiment of FIG. 1, for example, the audio codecs reside on separate subsystems, thus the video data stream must be managed across multiple processors. Also, non-codec related overhead, such as DRM encoding, may introduce a known amount of delay into the data stream.

In FIG. 1, the modem 110 provides an interface to the application entity 120 for setting the capturing and rendering video delay parameters used to calculate the queuing delay for audio/video synchronization. The exemplary interface is between the video application entity 123 and the H.324 entity 112. In the exemplary embodiment, the video application entity 123 also communicates with the video stream manager 120 and the audio stream manager 132.

In FIG. 1, the quantity of time to hold off multiplexing audio and video and the quantity of time to hold off decoding audio after performing an H.223 de-multiplexing operation is provided over the interface between the video application entity 123 and the H.324 entity. These exemplary parameters are used to calculate delay variables for audio/video synchronization. As suggested above, in some embodiments, the delay or skew changes are based on changes in the source from which one or more of the data stream originate and/or based on other conditions, for example, the particular processing to which the one or more data streams are subjected.

In one embodiment, in a portable multimedia device, a data stream originating from a selected source is synchronized with another data stream originating from another unsynchronized source based on delay or skew between the sources from which the data streams originate. In the exemplary multimedia device of FIG. 1, the selected data stream and the other data stream are synchronized prior to multiplexing and transmission over an air interface.

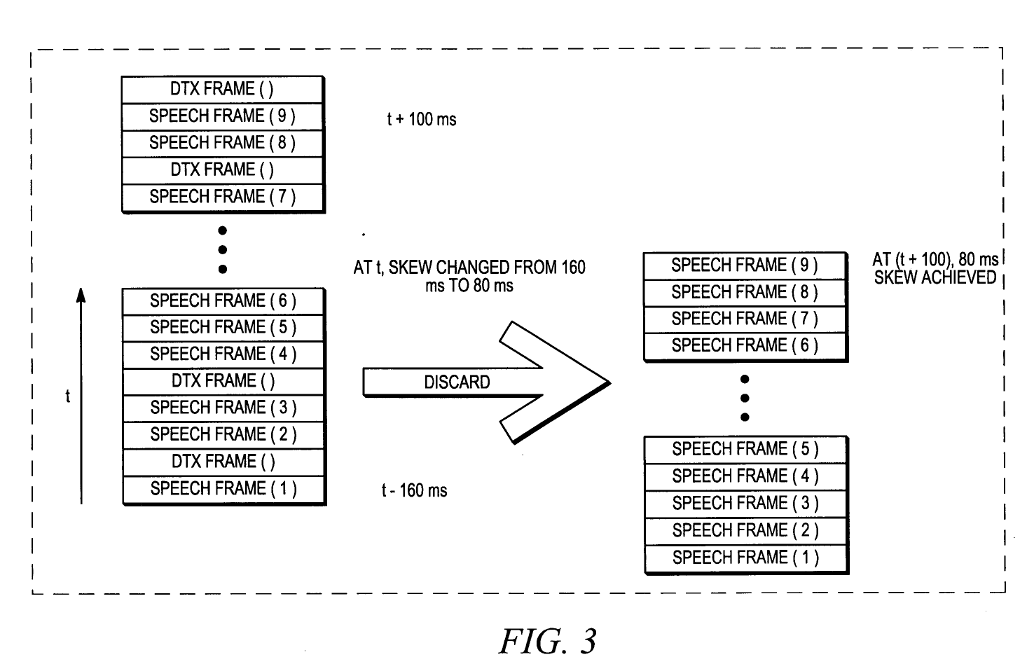

In one embodiment where the skew or delay changes, first and second data streams are gradually synchronized over a transient time period or interval. In some embodiments, for example, where the delay decreases from a higher value to a lower value, gradual synchronization may be obtained by removing frames from one of the data streams. In the exemplary embodiment where the first and second data streams are audio and video data streams, limited-data bearing frames, for example, DTX frames, are removed from the audio data stream. In the exemplary embodiment of FIG. 3, at time “t”, the skew is changed from 160 ms to 80 ms. Gradual synchronization to the new skew rate is achieved by removing DTX frames from the audio stream over a period of 100 ms. In other embodiments, the video and audio data streams may be gradually synchronized by selectively removing frames from the video data stream. In the exemplary embodiment of FIG. 1, frame removal is performed in the H.324 entity, although in other embodiments the frame removal may be performed by any other synchronization entity or device capable of selective frame or data removal.

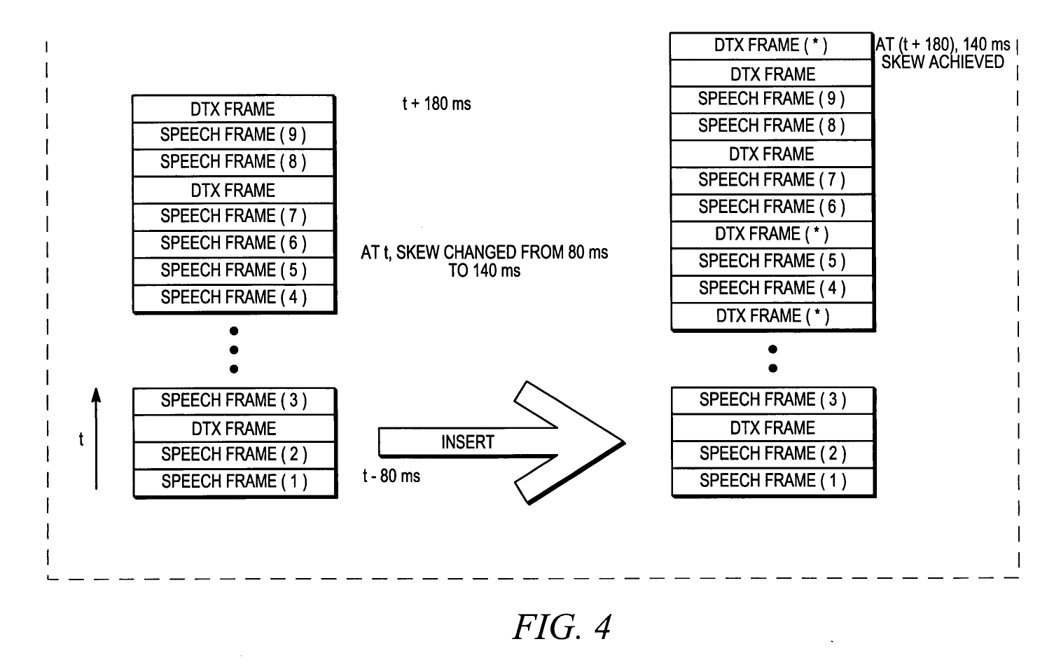

In other embodiments, for example, where the delay increases from a lower value to a higher value, gradual synchronization may be obtained by adding or inserting frames into one of the data streams. In the exemplary embodiment where the first and second data streams are audio and video data streams, limited-data bearing frames, for example, DTX frames, are inserted into the audio data stream. In the exemplary embodiment of FIG. 4, at time “t”, the skew is changed from 80 ms to 140 ms. Gradual synchronization to the new skew is achieved by inserting DTX frames into the audio stream over a period of 180 ms. In other embodiments, the video and audio data streams may be gradually synchronized by selectively inserting frames into the video data stream. In the exemplary embodiment of FIG. 1, frame insertion is performed in the H.324 entity, although in other embodiments the insertion may be performed by any other entity or device capable of selective frame or data insertion. In applications where video is not fully synchronous, the data stream may be reduced or increased by a combination of frame and video bit rate increases or decreases.

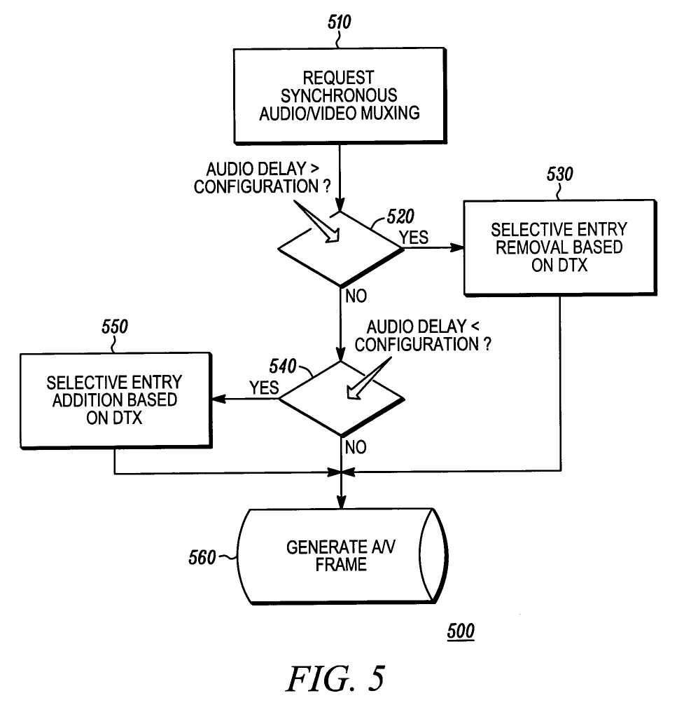

FIG. 5 illustrates an exemplary process 500 for multiplexing synchronized audio and video data streams, for example, at the H.324 entity in FIG. 1. At block 510, there is a request for synchronous audio and video multiplexing. In one embodiment, for example, the audio and video multiplexing occurs at a specified time interval, for example, every 20 ms, whether or not there is synchronization. In other embodiment, the interval varies, i.e., is not fixed. Generally, some interval of time may be required to synchronize the audio and video signals. This interval may vary depending, for example, on the availability of frames to remove.

In FIG. 5, at block 520, a determination is made whether there is audio delay that is greater than that of a reference configuration. If the audio delay is greater than the reference configuration, data, for example, DTX frames, are removed from the audio data stream at block 530. In some embodiments, frames are selectively removed until the new skew rate is achieved. Meanwhile, frames are multiplexed at the specified rate at block 560, whether or not synchronization is complete. At block 540, a determination is made whether the delay is less than that of a reference configuration. If the audio delay is less than the reference configuration, frames, for example, DTX frames, are selectively inserted into the audio data stream at block 550 until the new skew rate is achieved. Meanwhile, frames are multiplexed at the specified rate at block 560, whether or not synchronization is complete.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a portable multimedia device, the method comprising:
selecting a data stream originating from one of at least two sources;
synchronizing the selected data stream and the another data stream originating from another unsynchronized source based on skew between the source from which the selected data stream originates and the another source.

2. The method of claim 1,
changing to a new skew upon selecting the data stream,
the new skew different than a prior skew associated with a prior selected data stream,
gradually synchronizing the selected data stream and the another data stream over a time period to accommodate the new skew.

3. The method of claim 2,
the new skew is less than the prior skew,
gradually synchronizing the selected data stream and the another data stream by selectively removing frames from one of the selected data stream and the another data stream over the time period.

4. The method of claim 3,
the selected data stream is a video data stream and the another data stream is an audio data stream,
gradually synchronizing the audio and video data streams by selectively removing limited-data bearing frames from the audio data stream.

5. The method of claim 3,
the selected data stream is a video data stream and the another data stream is an audio data stream,
gradually synchronizing the audio and video data streams by selectively removing frames from the video data stream.

6. The method of claim 2,
the new skew is greater than the prior skew,
gradually synchronizing the selected data stream and the another data stream by inserting frames into one of the selected data stream and the another data stream.

7. The method of claim 1,
synchronizing the selected data stream and the another data stream prior to transmission of the synchronized selected data stream and another data stream.

8. The method of claim 1,
multiplexing the selected data stream and the another data stream after synchronizing,
synchronizing based on delay parameters dependent on the source of the selected data stream.

9. A multimedia enabled portable communication device, comprising:
an application processor;
a real-time processor unsynchronized with the application processor;
a synchronization entity communicably coupled to the application processor and the real-time processor,
the synchronization entity synchronizing the video information from the application processor with audio information from the real-time processor based on delay information.

10. The device of claim 9,
a timing control entity associated with one of the application processor and the real-time processor;
the synchronization entity communicably coupled to the timing control entity, the timing control entity providing the delay information to the synchronization entity.

11. The device of claim 9,
the application processor having a video stream manager that obtains video information from one of at least two sources, and
the timing control entity providing delay information based on the source from which the video information is obtained.

12. The device of claim 9, the synchronization entity for gradually synchronizing the audio and video information in response to a change in delay information.

13. The device of claim 12, the synchronization entity for gradually synchronizing the audio and video information by removing frames from one of the audio and video information.

14. The device of claim 12, the synchronization entity for gradually synchronizing the audio and video information by inserting frames into one of the audio and video information.

15. A method in a multimedia enabled electronic device, the method comprising:
obtaining first and second data streams from corresponding unsynchronized sources;
compensating for a change in delay between the first and second data streams by gradually synchronizing the first and second data streams over a time interval.

16. The method of claim 15,
compensating for the change in delay between the first and second data streams by selectively removing frames from one of the first and second data streams over the time interval.

17. The method of claim 16,
the first data stream is an audio data stream and the second data stream is a video data stream,
compensating for the change in delay between the first and second data streams by removing limited-data bearing frames from one of the audio data stream and the video data stream.

18. The method of claim 15,
compensating for the change in delay between the first and second data streams by inserting frames into one of the first and second streams.

19. The method of claim 15,
the first data stream is an audio data stream and the second data stream is a video data stream,
compensating for the change in delay between the first and second data streams by inserting limited-data bearing frames into one of the audio and video data stream.

20. The method of claim 15,
changing the delay by changing a source from which one of the first and second data streams originates.

21. The method of claim 15, changing the delay by processing one of the first and second data streams.

22. The method of claim 15, multiplexing the synchronized first and second data streams.
